(19) United States
(12) Patent Application Publication
(10) Pub. No.: US 2024/0073740 A1
(43) Pub. Date: Feb. 29, 2024

(54) METHOD AND APPARATUS FOR PERFORMING TASK OFFLOADING BETWEEN TERMINAL AND SATELLITE IN MEC NETWORK

(71) Applicant: Daegu Gyeongbuk Institute of Science and Technology, Daegu (KR)

(72) Inventors: Jeong Hwan KIM, Daegu (KR); Jeong Ho KWAK, Daegu (KR); Tae Yeoun KIM, Daegu (KR); Dong Ho HAM, Daegu (KR)

(21) Appl. No.: 18/230,216

(22) Filed: Aug. 4, 2023

(30) Foreign Application Priority Data
Aug. 23, 2022 (KR) 10-2022-0105395

(51) Int. Cl. H04W 28/086; H04W 28/02

(52) U.S. Cl. CPC H04W 28/086; H04W 28/0284; H04W 28/0289

(57) ABSTRACT

There is provided a method of a terminal for performing task offloading with at least one satellite in an MEC network. The method includes the steps of: acquiring at least one initial input value; acquiring information needed for determining whether or not to perform task offloading, from the at least one satellite in time slot t; setting an object function according to whether or not to perform task offloading on the basis of information on the terminal and the information needed for determining whether or not to perform task offloading acquired from the at least one satellite in time slot t; acquiring a minimum value of each object function according to whether or not to perform task offloading, and comparing the minimum value of each object function; and determining whether or not to perform task offloading to the at least one satellite in time slot t according to a result of the comparison.

### BACKGROUND OF THE INVENTION

### Field of the Invention

The present disclosure provides a method of performing task offloading between a terminal and a satellite in an MEC network.

### Background of the Related Art

With advancement in the 5th generation communication technology (5G), numerous devices are invented in the age of Internet of Things (IoT), and many tasks requiring large computational resources have been generated. In such an IoT environment, multiaccess edge computing (MEC) has emerged as a technique that can efficiently satisfy high computational demands in a device (e.g., terminal device) by offloading tasks requiring high computing performance from the device to a nearby MEC server. In addition, studies on applying the MEC task offloading method to a MEC network model between a terminal and a satellite are under progress.

FIG. 1 is a view showing an MEC network 100 model between a terminal including a terrestrial satellite terminal (TST) and a satellite used in an embodiment of the present disclosure.

Referring to FIG. 1, an MEC network 100 includes one or more terminals 101 and one or more satellites 102. For example, one or more terminals 101 may include an IoT mobile device (IMD). For example, one or more satellites 102 may be satellites moving in a low earth orbit. Each of the one or more satellites 102 includes a MEC server 104. The MEC network 100 includes a terrestrial satellite terminal (TST) 103 disposed between one or more terminals 101 and one or more satellites 102 and operating as a connection point. The TST 103 performs a function of collecting offloading tasks from one or more terminals 101 and simultaneously upload the tasks onto one or more satellites 102. At this point, the TST 103 performs an algorithm for jointly optimizing latency and energy between one or more terminals 101 and one or more satellites 102.

Although the existing task offloading technique proposed in FIG. 1 has presented an optimization problem of adjusting the trade-off between a TST transmission power and an offloading ratio, there is a problem in that it does not consider realistic situations such as a dynamic situation in which satellites move in real time.

Therefore, an edge computing optimization model between a terminal and a satellite, which is more realistic than the basic according to dynamic optimization, is required in consideration of the distance and propagation latency between the terminal and the satellite that change in real time with respect to continuously moving low-orbit satellites.

### SUMMARY OF THE INVENTION

Therefore, the present disclosure has been made in view of the above problems, and it is an object of the present disclosure to provide a method and apparatus for performing task offloading between a terminal and a satellite in an MEC network.

According to an embodiment of the present disclosure, there is provided a method of a terminal for performing task offloading with at least one satellite in an MEC network. The method includes the steps of: acquiring at least one initial input value; acquiring information needed for determining whether or not to perform task offloading, from the at least one satellite in time slot t; setting an object function according to whether or not to perform task offloading on the basis of information on the terminal and the information needed for determining whether or not to perform task offloading acquired from the at least one satellite in time slot t; acquiring a minimum value of each object function according to whether or not to perform task offloading, and comparing the minimum value of each object function; and determining whether or not to perform task offloading to the at least one satellite in time slot t according to a result of the comparison.

According to an embodiment of the present disclosure, there is provided a terminal for performing task offloading with at least one satellite in an MEC network, the terminal comprising: a transceiver; and a control unit for controlling the transceiver, wherein the control unit acquires at least one initial input value, acquires information needed for determining whether or not to perform task offloading, from the at least one satellite in time slot t, sets an object function according to whether or not to perform task offloading on the basis of information on the terminal and the information needed for determining whether or not to perform task offloading acquired from the at least one satellite in time slot t, acquires a minimum value of each object function according to whether or not to perform task offloading, and compares the minimum value of each object function, and determines whether or not to perform task offloading to the at least one satellite in time slot t according to a result of the comparison.

### BRIEF DESCRIPTION OF THE DRAWINGS

FIG. 1 is a view showing an example of an MEC network model between a terminal including a TST and a satellite according to the prior art.

FIG. 2 is a view showing an example of an MEC network model between a terminal and a satellite according to an embodiment of the present disclosure.

FIG. 3 is a flowchart illustrating an algorithm for determining whether or not to perform task offloading in an MEC network model between a terminal and a satellite according to an embodiment of the present disclosure.

FIG. 4 is a block diagram showing a terminal performing task offloading in an MEC network model between a terminal and a satellite according to an embodiment of the present disclosure.

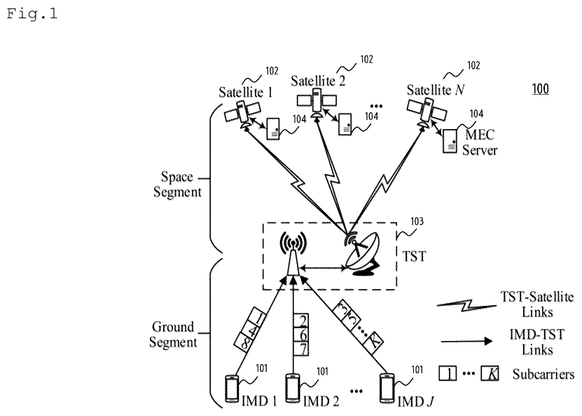

### DETAILED DESCRIPTION OF THE PREFERRED EMBODIMENT

Hereinafter, embodiments of the present disclosure will be described in detail with reference to the accompanying drawings so that those skilled in the art may easily embody the present disclosure. However, it should be understood that this disclosure is not limited to specific embodiments, and includes all changes, equivalents, and substitutes included in the spirit and technical scope of the disclosure. In addition, parts irrelevant to the description of the present disclosure are omitted in the drawings, and like reference numerals are assigned to like parts throughout the specification.

Although terms such as first, second, A, B, and the like may be used to describe various components, the components are not limited by the terms, and the terms are used only to distinguish one component from another. For example, a first component may be named as a second component, and similarly, a second component may be named as a first component, without departing from the scope of the present disclosure. The term “and/or” includes any combination of a plurality of related listed items or any one of a plurality of related listed items.

In the terms used in this specification, it should be understood that singular expressions include plural expressions unless the context clearly dictates otherwise. In addition, it should be understood that the term “includes” or the like means presence of embodied features, numbers, steps, operations, components, parts, or combinations thereof, and does not exclude presence or addition of one or more other features, numbers, steps, operations, components, parts, or combinations thereof.

It is to clearly classify the components in this specification by the main function of each component before describing the drawings in detail. That is, two or more components described below may be combined into one component, or one component may be divided into two or more components for each subdivided function.

In addition, it is apparent that each of the components described below may additionally perform some or all of the functions of other components in addition to its main function, and some of the main functions of each component may be exclusively performed by other components. Therefore, existence of each component described through this specification should be interpreted functionally.

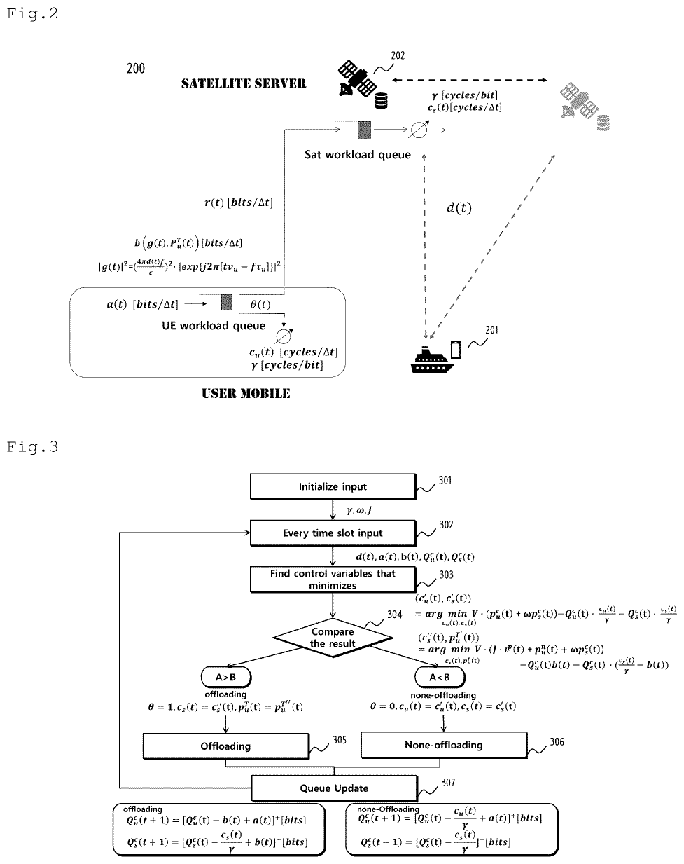

FIG. 2 is a view showing an example of an MEC network model 200 between a terminal and a satellite according to an embodiment of the present disclosure.

Referring to FIG. 2, an MEC network 200 includes one or more terminals 201 and one or more satellites 202. For example, one or more terminals 201 may include an IMD. For example, one or more satellites 202 may be satellites moving in a low earth orbit. Each of the one or more satellites 202 includes a MEC server (not shown). One or more terminals 201 and one or more satellites 202 are spaced apart by a distance d(t) in time slot t. One or more terminals 201 have an average task amount a(t) (bit/Δt) coming into one or more terminals 201 in time slot t. One or more terminals 201 determine whether or not to perform task offloading to one or more satellites 202 according to an offloading schedule parameter θ(t) in time slot t. For example, when the offloading schedule parameter θ(t) shows a specific value (e.g., 0) in time slot t indicating that offloading is not performed, one or more terminals 201 process the task using an amount γ of CPU resources used per bit (cycles/bit) required to process the task and the CPU processing speed cᵤ(t)Hz of the one or more terminals 201 in time slot as the average task amount a(t). For example, when the offloading schedule parameter θ(t) shows a specific value (e.g., 1) indicating that offloading is performed in time slot t, one or more terminals 201 transfer a processing amount b(t) (bit/Δt) to one or more satellites 202 in time slot t.

The processing amount b(t) is a function of a channel gain value g(t) between one or more terminals 201 and one or more satellites 202 in time slot t and the transmission power pᵤ^{T} of one or more terminals 201 to one or more satellites 202 in time slot t. The channel gain value g(t) between one or more terminals 201 and one or more satellites 202 in time slot t may be expressed as a function of distance d(t) between one or more terminals 201 and one or more satellites 202 in time slot t as shown below in Equation 1.

$${\vert g ( t ) \vert}^{2} = {( \frac{4 π d ( t ) f}{c} )}^{2} \cdot {\vert exp \{ j 2 π [ {tv}_{u} - f {τ}_{u} ] \} \vert}^{2} \qquad 〈 Equation 1 〉$$

Here, f denotes the frequency of radio waves transmitted from one or more terminals 201 to one or more satellites 202, c denotes the speed of light, vᵤ denotes the Doppler frequency, and τᵤ denotes propagation latency.

One or more satellites 202 receiving the processing amount b(t) from one or more terminals 201 process the task using an amount γ of CPU resources used per bit (cycles/bit) required to process the task and the CPU processing speed cₛ(t)Hz of the one or more satellites 202 in time slot.

FIG. 3 is a flowchart illustrating an algorithm for determining whether or not to perform task offloading in an MEC network model 200 between a terminal and a satellite according to an embodiment of the present disclosure.

Referring to FIG. 3, an algorithm for determining whether or not to perform task offloading may be performed by one or more terminals 201 in FIG. 2. At step 301, one or more terminals 201 have, as initial input values, an amount γ of CPU resources used per bit (cycles/bit) required to process a task, parameter ω for balancing CPU power of each of the one or more terminals 201 and the one or more satellites 202, and parameter J for balancing energy consumption and latency in the MEC network 200 including one or more terminals 201 and one or more satellites 202.

At step 302, one or more terminals 201 have a(t), b(t), d(t), pᵤ^{T}, cᵤ(t), and cₛ(t) as input values in time slot t, a CPU processing queue backlog Qᵤ^{c}(t) (bits) of one or more terminals 201 at time slot t, and/or a CPU processing queue backlog Qₛ^{c}(t) (bits) of one or more satellites 202 in time slot t.

At step 303, one or more terminals 201 set an object function for minimizing energy consumption and latency in the MEC network 200 including one or more terminals 201 and one or more satellites 202, on the basis of energy consumed in the MEC network 200, power of the MEC network 200, and queue latency to be observed. For example, since the energy consumed in the MEC network 200, power of the MEC network 200, and queue latency to be observed change in every time slot in the object function, one or more terminals 201 use Lyapunov optimization, which is a dynamic optimization technique, to minimize the total sum of the energy consumed in the MEC network 200, power of the MEC network 200, and queue latency to be observed, each of which is multiplied by a weight. At this point, when the Lyapunov optimization is applied according to the offloading schedule parameter θ(t) in time slot t, the relational expression between the object function expressed as controllable variables cᵤ(t), cₛ(t), and pᵤ^{T}(t) and stabilization of the queue is as shown below in Equations 2 and 3.

$$( {c}_{u}^{*} ( t ) , {c}_{s}^{*} ( t ) ) = arg {min}_{{c}_{u} ( t ) , {c}_{s} ( t )} V \cdot ( {p}_{u}^{c} ( t ) + ω {p}_{s}^{*} ( t ) ) - {Q}_{u}^{c} ( t ) \cdot \frac{{c}_{u} ( t )}{γ} - {Q}_{s}^{c} ( t ) \cdot \frac{{c}_{s} ( t )}{γ} \qquad 〈 Equation 2 〉$$

$$( {c}_{s}^{* *} ( t ) , {p}_{u}^{{T}^{*}} ( t ) ) = arg {min}_{{c}_{u} ( t ) , {p}_{u}^{T} ( t )} V \cdot ( J \cdot {l}^{p} ( t ) + {p}_{u}^{n} ( t ) + ω {p}_{s}^{c} ( t ) ) - {Q}_{u}^{c} ( t ) \cdot b ( t ) - {Q}_{s}^{c} ( t ) \cdot ( \frac{{c}_{s} ( t )}{γ} - b ( t ) ) \qquad 〈 Equation 3 〉$$

Here, V denotes a parameter indicating the weight between stabilization of the queue and the object function in a trade-off relation, pᵤ^{c}(t) denotes CPU processing power of one or more terminals 201 in time slot t, pₛ^{c}(t) denotes CPU processing power of one or more satellites 202 in time slot t, pᵤⁿ(t) denotes power of the MEC network 200 associated with pᵤ^{T}(t) of one or more terminals 201 in time slot t, and l^{p}(t) denotes propagation latency in time slot t.

That is, when the offloading schedule parameter θ(t) shows a specific value (e.g., 0) indicating that offloading is not performed in time slot t, cᵤ*(t) and cₛ*(t) that minimize the relational expression between the object function and stabilization of the queue are acquired by adjusting controllable variables cᵤ(t) and cₛ(t) through Equation 2. Specifically, a combination of cᵤ(t) and cₛ(t) that minimize the result value of Equation 2 is acquired as cᵤ*(t) and cₛ*(t) by substituting values of possible combinations of cᵤ(t) and cₛ(t).

In addition, when the offloading schedule parameter θ(t) shows a specific value (e.g., 1) indicating that offloading is performed in time slot t, cₛ**(t) and pₛ^{T}*(t) that minimize the relational expression between the object function and stabilization of the queue are acquired by adjusting controllable variables cₛ(t) and pᵤ^{T}(t) through Equation 3. Specifically, Equation 3 is divided into terms of cₛ(t) and pᵤ^{T}(t), and for the term cₛ(t), cₛ(t) that minimizes the corresponding term is acquired as cₛ**(t) by substituting all possible values of cₛ(t), and for the term pᵤ^{T}(t), pᵤ^{T}(t) that minimizes the corresponding term is acquired as pₛ*(t) through differentiation.

At step 304, in order for one or more terminals 201 to determine whether or not to perform task offloading to one or more satellites 202, A that minimizes the relation between the object function and stability of the queue when task offloading is not performed (e.g., θ(t)=0), and B that minimizes the relation between the object function and stability of the queue when task offloading is performed (e.g., θ(t)=1) are expressed as shown in Equation 4 and Equation 5.

$$A = V \cdot ( {p}_{u}^{c} ( t ) + ω {p}_{s}^{c} ( t ) ) - {Q}_{u}^{c} ( t ) \cdot \frac{{c}_{u}^{*} ( t )}{γ} - {Q}_{s}^{c} ( t ) \cdot \frac{{c}_{s}^{*} ( t )}{γ} \qquad 〈 Equation 4 〉$$

$$B = V \cdot ( J \cdot {l}^{p} ( t ) + {p}_{u}^{n} ( {p}_{u}^{{T}^{*}} ( t ) , t ) + ω {p}_{s}^{c} ( t ) ) - {Q}_{u}^{c} ( t ) \cdot b ( t ) - {Q}_{s}^{c} ( t ) \cdot ( \frac{{c}_{s}^{* *} ( t )}{γ} - b ( t ) ) \qquad 〈 Equation 5 〉$$

That is, A and B are values acquired by substituting control variables (cᵤ*(t), cₛ*(t)) and (cₛ**(t), pₛ^{T}*(t)) that minimize the equations obtained at step 303 into Equations 2 and 3.

One or more terminals 201 compare values of A and B. At this point, since A and B represent minimum values of the upper boundary values of the object function including queue stability when task offloading is not performed and when task offloading is performed, respectively, the smaller one of A and B may minimize the object function in a corresponding case. One or more terminals 201 perform step 305 when A is greater than B and perform step 306 when A is smaller than B.

When A is greater than B, at step 305, one or more terminals 201 determine to perform task offloading to one or more satellites 202 in time slot t, and transfer a task for performing offloading to one or more satellites 202.

When A is smaller than B, at step 306, one or more terminals 201 determine not to perform task offloading to one or more satellites 202 in time slot t, and process a corresponding task by themselves.

At step 307, one or more terminals 201 and one or more satellites 202 repeat updating the queue and determining whether or not to perform task offloading in time slot t+1. For example, when one or more terminals 201 have performed task offloading to one or more satellites 202 at step 305, queue backlog Qᵤ^{c}(t+1) of one or more terminals 201 and queue backlog Qₛ^{c}(t+1) of one or more satellites 202 in time slot t+1 are updated according to Equations 6 and 7, respectively.

$${Q}_{u}^{c} ( t + 1 ) = {[ {Q}_{u}^{c} ( t ) - b ( t ) + a ( t ) ]}^{+} ( bits ) \qquad 〈 Equation 6 〉$$

$${Q}_{s}^{c} ( t + 1 ) = {[ {Q}_{s}^{c} ( t ) - \frac{{c}_{s} ( t )}{γ} + b ( t ) ]}^{+} ( bits ) \qquad 〈 Equation 7 〉$$

That is, as much processing amount as b(t) goes out from the processing queue of one or more terminals 201 and as much processing amount as b(t) comes into the processing queue of one or more satellites 202. In addition, regardless of off-roading, as much processing amount as a(t) comes into the processing queue of one or more terminals 201, and as much processing amount as cₛ(t)/γ goes out from the processing queue of one or more satellites 202 as a CPU processing amount.

For example, when one or more terminals 201 do not perform task offloading to one or more satellites 202 at step 306, queue backlog Qᵤ^{c}(t+1) of one or more terminals 201 and queue backlog Qᵤ^{c}(t+1) of one or more satellites 202 are updated in time slot t+1 as shown in Equations 8 and 9, respectively.

$${Q}_{u}^{c} ( t + 1 ) = {[ {Q}_{u}^{c} ( t ) - \frac{{c}_{u} ( t )}{γ} + a ( t ) ]}^{+} ( bits ) \qquad 〈 Equation 8 〉$$

$${Q}_{s}^{c} ( t + 1 ) = {[ {Q}_{s}^{c} ( t ) - \frac{{c}_{s} ( t )}{γ} ]}^{+} ( bits ) \qquad 〈 Equation 8 〉$$

That is, as much processing amount as cₛ(t)/γ goes out from the processing queue of one or more terminals 201 as a CPU processing amount, and as much processing amount as a(t) comes into the processing queue. In addition, as much processing amount as cₛ(t)/γ goes out from the processing queue of one or more satellites 202 as a CPU processing amount.

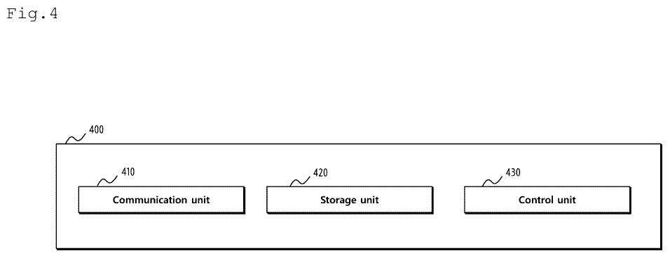

FIG. 4 is a block diagram showing a terminal 400 performing task offloading in an MEC network model between a terminal and a satellite according to an embodiment of the present disclosure. In FIG. 4, the terminal 400 may correspond to one or more terminals 201 of the MEC network 200 of FIG. 2.

Referring to FIG. 4, the terminal 400 includes a communication unit 410, a storage unit 420, and a control unit 430.

The communication unit 410 receives information needed for determining whether or not to perform task offloading from one or more satellites (e.g., one or more satellites 201 of FIG. 2) in every time slot. For example, information needed for determining whether or not to perform task offloading includes information on the CPU processing queue backlog Qₛ^{c}(t) of one or more satellites in time slot t and/or information on the CPU processing speed cₛ(t) of one or more satellites in time slot t.

The storage unit 420 stores the algorithm according to the present disclosure and information needed for determining whether or not to perform task offloading received from one or more satellites. The storage unit 420 may be implemented as a memory of the terminal 400.

The control unit 430 determines whether or not to perform task offloading by performing an algorithm according to the present disclosure by using information needed for determining whether or not to perform task offloading received from one or more satellites and information on the terminal 400 (e.g., information on the CPU processing queue backlog Qᵤ^{c}(t) of the terminal 400 in time slot t and/or the CPU processing speed cᵤ(t) of one or more satellites in time slot t). The control unit 430 may be implemented as a central processing unit (CPU) or an application processor (AP) of the terminal 400. In addition, the control unit 430 performs task offloading to one or more satellites through the communication unit 410 or processes the task by itself, according to a result of performing the algorithm.

Meanwhile, the terminal 400 as described above may be implemented as a program (or application) including an executable algorithm that can be executed on a computer. The program may be stored in and provided by a transitory or non-transitory computer readable medium.

The non-transitory computer readable medium is not a medium that stores data for a short moment, such as a register, cache, or memory, but a medium that stores data semi-permanently and can be read by a device. Specifically, the various applications or programs described above may be stored in and provided by a non-transitory readable medium such as a CD, DVD, hard disk, Blu-ray disk, USB, memory card, read-only memory (ROM), programmable read-only memory (PROM), erasable PROM (EPROM), electrically EPROM (EEPROM), flash memory, or the like.

The transitory computer readable medium means various random-access memories (RAMs) such as static RAM (SRAM), dynamic RAM (DRAM), synchronous DRAM (SDRAM), double data rate SDRAM (DDR SDRAM), enhanced SDRAM (ESDRAM), ESDRAM), synclink DRAM (SLDRAM), and direct rambus RAM (DRRAM).

Although the reinforcement learning-based user selection method and apparatus for uplink communication according to an embodiment of the present disclosure have been described with reference to the embodiments shown in the drawings to help understanding, this is only an example, and those skilled in the art will understand that various modifications and equivalent other embodiments are possible therefrom. Therefore, the true technical protection scope of the present disclosure should be defined by the appended claims.

The embodiments of the present disclosure may have effects including following advantages. However, since this does not mean that the embodiments of the present disclosure should include all of these effects, the scope of rights of the present disclosure should not be construed as being limited by the effects.

According to an embodiment of the present disclosure, dynamic optimization may be performed in consideration of the distance and propagation latency between a terminal and a satellite that change in real time with respect to continuously moving satellites.

In addition, according to an embodiment of the present disclosure, a more realistic edge computing optimization model between a terminal and a satellite can be provided.

What is claimed is:

1. A method of a terminal for performing task offloading with at least one satellite in a multiaccess edge computing (MEC) network, the method comprising the steps of:
acquiring at least one initial input value;
acquiring information needed for determining whether or not to perform task offloading, from the at least one satellite in time slot t;
setting an object function according to whether or not to perform task offloading on the basis of information on the terminal and the information needed for determining whether or not to perform task offloading acquired from the at least one satellite in time slot t;
acquiring a minimum value of each object function according to whether or not to perform task offloading, and comparing the minimum value of each object function; and
determining whether or not to perform task offloading to the at least one satellite in time slot t according to a result of the comparison.

2. The method according to claim 1, wherein the at least one initial input value includes at least one among an amount γ of CPU resources used per bit, required to process a task, parameter ω for balancing CPU power of each of the terminal and the at least one satellite, and parameter J for balancing energy consumption and latency of the MEC network.

3. The method according to claim 2, wherein
the information on the terminal includes at least one among a CPU processing speed cu(t) of the terminal in time slot t, a CPU processing queue backlog Qᵤ^{c}(t) of the terminal, a transmission power pᵤ^{T} of the terminal to the at least one satellite, and a processing amount b(t) transferred from the terminal to the at least one satellite, and the information needed for determining whether or not to perform task offloading acquired from the at least one satellite includes at least one among a CPU processing speed cₛ(t) of the at least one satellite, and a CPU processing queue backlog Qₛ^{c}(t) of the at least one satellite, and b(t) is determined based on a distance d(t) between the terminal and the at least one satellite in time slot t.

4. The method according to claim 3, wherein the step of setting an object function according to whether or not to perform task offloading includes the steps of:
setting an object function to satisfy conditions of Equation 1 when the task offloading is not performed; and
setting an object function to satisfy conditions of Equation 2 when the task offloading is performed.
$$( {c}_{u}^{*} ( t ) , {c}_{s}^{*} ( t ) ) = arg {min}_{{c}_{u} ( t ) , {c}_{s} ( t )} V \cdot ( {p}_{u}^{c} ( t ) + ω {p}_{s}^{*} ( t ) ) - {Q}_{u}^{c} ( t ) \cdot \frac{{c}_{u} ( t )}{γ} - {Q}_{s}^{c} ( t ) \cdot \frac{{c}_{s} ( t )}{γ} \qquad 〈 Equation 1 〉$$
$$( {c}_{s}^{* *} ( t ) , {p}_{u}^{{T}^{*}} ( t ) ) = arg {min}_{{c}_{u} ( t ) , {p}_{u}^{T} ( t )} V \cdot ( j \cdot {l}^{p} ( t ) + {p}_{u}^{n} ( t ) + ω {p}_{s}^{c} ( t ) ) - {Q}_{u}^{c} ( t ) \cdot b ( t ) - {Q}_{s}^{c} ( t ) \cdot ( \frac{{c}_{s} ( t )}{γ} - b ( t ) ) \qquad 〈 Equation 2 〉$$
Here, V denotes a parameter indicating a weight between stabilization of a queue and each object function in a trade-off relation, pᵤ^{c}(t) denotes CPU processing power of the terminal in time slot t, pₛ^{c}(t) denotes CPU processing power of the at least one satellite in time slot t, pᵤⁿ(t) denotes power of the MEC network associated with pᵤ^{T}(t) of the terminal in time slot t, and l^{p}(t) denotes propagation latency in time slot t.

5. The method according to claim 4, wherein the step of acquiring a minimum value of each object function includes the steps of:
acquiring a minimum value of the object function as shown in Equation 3 when the task offloading is not performed; and
acquiring a minimum value of the object function as shown in Equation 4 when the task offloading is performed.
$$A = V \cdot ( {p}_{u}^{c} ( t ) + ω {p}_{s}^{c} ( t ) ) - {Q}_{u}^{c} ( t ) \cdot \frac{{c}_{u}^{*} ( t )}{γ} - {Q}_{s}^{c} ( t ) \cdot \frac{{c}_{s}^{*} ( t )}{γ} \qquad 〈 Equation 3 〉$$
$$B = V \cdot ( j \cdot {l}^{p} ( t ) + {p}_{u}^{n} ( {p}_{u}^{{T}^{*}} ( t ) , t ) + ω {p}_{s}^{c} ( t ) ) - {Q}_{u}^{c} ( t ) \cdot b ( t ) - {Q}_{s}^{c} ( t ) \cdot ( \frac{{c}_{s}^{* *} ( t )}{γ} - b ( t ) ) \qquad 〈 Equation 4 〉$$
Here, A denotes a minimum value of the object function when the task offloading is not performed,
cᵤ*(t) and cₛ*(t) denote the CPU processing speed of the terminal and a CPU processing speed of the at least one satellite when Equation 1 is satisfied,
B denotes a minimum value of the object function when the task offloading is performed, and
cₛ**(t) and pₛ^{T}*(t) denote a CPU processing speed of the at least one satellite and transmission power of the terminal to the at least one satellite when Equation 2 is satisfied.

6. The method according to claim 5, wherein the step of determining whether or not to perform task offloading to the at least one satellite in time slot t according to a result of the comparison includes the steps of:
determining to perform the task offloading to the at least one satellite when A is greater than B; and
determining not to perform the task offloading to the at least one satellite when A is smaller than B.

7. The method according to claim 6, further comprising the step of updating the queue of the terminal on the basis of whether or not to perform the task offloading.

8. The method according to claim 7, wherein the step of updating the queue of the terminal on the basis of whether or not to perform the task offloading includes the steps of:
updating the CPU processing queue backlog Qᵤ^{c}(t+1) in time slot t+1 using Equation 5 when the task offloading is performed; and
updating the CPU processing queue backlog Qᵤ^{c}(t+1) in time slot t+1 using Equation 6 when the task offloading is not performed.
$${Q}_{u}^{c} ( t + 1 ) = {[ {Q}_{u}^{c} ( t ) - b ( t ) + a ( t ) ]}^{+} ( bits ) \qquad 〈 Equation 5 〉$$
$${Q}_{s}^{c} ( t + 1 ) = {[ {Q}_{s}^{c} ( t ) - \frac{{c}_{u} ( t )}{γ} + a ( t ) ]}^{+} ( bits ) \qquad 〈 Equation 6 〉$$

9. A terminal for performing task offloading with at least one satellite in a multiaccess edge computing (MEC) network, the terminal comprising:
a transceiver; and
a control unit for controlling the transceiver, wherein
the control unit acquires at least one initial input value, acquires information needed for determining whether or not to perform task offloading, from the at least one satellite in time slot t, sets an object function according to whether or not to perform task offloading on the basis of information on the terminal and the information needed for determining whether or not to perform task offloading acquired from the at least one satellite in time slot t, acquires a minimum value of each object function according to whether or not to perform task offloading, and compares the minimum value of each object function, and determines whether or not to perform task offloading to the at least one satellite in time slot t according to a result of the comparison.

10. The terminal according to claim 9, wherein the at least one initial input value includes at least one among an amount γ of CPU resources used per bit, required to process a task, parameter ω for balancing CPU power of each of the terminal and the at least one satellite, and parameter J for balancing energy consumption and latency of the MEC network.

11. The terminal according to claim 10, wherein the information on the terminal includes at least one among a CPU processing speed cᵤ(t) of the terminal in time slot t, a CPU processing queue backlog Qᵤ^{c}(t) of the terminal, a transmission power pᵤ^{T} of the terminal to the at least one satellite, and a processing amount b(t) transferred from the terminal to the at least one satellite, and the information needed for determining whether or not to perform task offloading acquired from the at least one satellite includes at least one among a CPU processing speed cₛ(t) of the at least one satellite, and a CPU processing queue backlog Qₛ^{c}(t) of the at least one satellite, and b(t) is determined based on a distance d(t) between the terminal and the at least one satellite in time slot t.

12. The terminal according to claim 11, wherein the control unit sets an object function to satisfy conditions of Equation 1 when the task offloading is not performed, and sets an object function to satisfy conditions of Equation 2 when the task offloading is performed.
$$( {c}_{u}^{*} ( t ) , {c}_{s}^{*} ( t ) ) = arg {min}_{{c}_{u} ( t ) , {c}_{s} ( t )} V \cdot ( {p}_{u}^{c} ( t ) + ω {p}_{s}^{*} ( t ) ) - {Q}_{u}^{c} ( t ) \cdot \frac{{c}_{u} ( t )}{γ} - {Q}_{s}^{c} ( t ) \cdot \frac{{c}_{s} ( t )}{γ} \qquad 〈 Equation 1 〉$$
$$( {c}_{s}^{* *} ( t ) , {p}_{u}^{{T}^{*}} ( t ) ) = arg {min}_{{c}_{u} ( t ) , {p}_{u}^{T} ( t )} V \cdot ( j \cdot {l}^{p} ( t ) + {p}_{u}^{n} ( t ) + ω {p}_{s}^{c} ( t ) ) - {Q}_{u}^{c} ( t ) \cdot b ( t ) - {Q}_{s}^{c} ( t ) \cdot ( \frac{{c}_{s} ( t )}{γ} - b ( t ) ) \qquad 〈 Equation 2 〉$$
Here, V denotes a parameter indicating a weight between stabilization of a queue and each object function in a trade-off relation, pᵤ^{c}(t) denotes CPU processing power of the terminal in time slot t, pₛ^{c}(t) denotes CPU processing power of the at least one satellite in time slot t, pᵤⁿ(t) denotes power of the MEC network associated with pᵤ^{T}(t) of the terminal in time slot t, and l^{p}(t) denotes propagation latency in time slot t.

13. The terminal according to claim 12, wherein the control unit acquires a minimum value of the object function as shown in Equation 3 when the task offloading is not performed, and acquires a minimum value of the object function as shown in Equation 4 when the task offloading is performed.
$$A = V \cdot ( {p}_{u}^{c} ( t ) + ω {p}_{s}^{c} ( t ) ) - {Q}_{u}^{c} ( t ) \cdot \frac{{c}_{u}^{*} ( t )}{γ} - {Q}_{s}^{c} ( t ) \cdot \frac{{c}_{s}^{*} ( t )}{γ} \qquad 〈 Equation 3 〉$$
$$B = V \cdot ( j \cdot {l}^{p} ( t ) + {p}_{u}^{n} ( {p}_{u}^{{T}^{*}} ( t ) , t ) + ω {p}_{s}^{c} ( t ) ) - {Q}_{u}^{c} ( t ) \cdot b ( t ) - {Q}_{s}^{c} ( t ) \cdot ( \frac{{c}_{s}^{* *} ( t )}{γ} - b ( t ) ) \qquad 〈 Equation 4 〉$$
Here, A denotes a minimum value of the object function when the task offloading is not performed,
cᵤ*(t) and cₛ*(t) denote the CPU processing speed of the terminal and a CPU processing speed of the at least one satellite when Equation 1 is satisfied,
B denotes a minimum value of the object function when the task offloading is performed, and
cₛ**(t) and pₛ^{T}*(t) denote a CPU processing speed of the at least one satellite and transmission power of the terminal to the at least one satellite when Equation 2 is satisfied.

14. The terminal according to claim 13, wherein the control unit determines to perform the task offloading to the at least one satellite when A is greater than B, and determines not to perform the task offloading to the at least one satellite when A is smaller than B.

15. The terminal according to claim 14, wherein the control unit updates the queue of the terminal on the basis of whether or not to perform the task offloading.

16. The terminal according to claim 15, wherein the control unit updates the CPU processing queue backlog Qᵤ^{c}(t+1) in time slot t+1 using Equation 5 when the task offloading is performed, and updates the CPU processing queue backlog Qᵤ^{c}(t+1) in time slot t+1 using Equation 6 when the task offloading is not performed.
$${Q}_{u}^{c} ( t + 1 ) = {[ {Q}_{u}^{c} ( t ) - b ( t ) + a ( t ) ]}^{+} ( bits ) \qquad 〈 Equation 5 〉$$
$${Q}_{s}^{c} ( t + 1 ) = {[ {Q}_{s}^{c} ( t ) - \frac{{c}_{u} ( t )}{γ} + a ( t ) ]}^{+} ( bits ) \qquad 〈 Equation 6 〉$$
